(19) United States
(12) Patent Application Publication
(10) Pub. No.: US 2003/0003020 A1
(43) Pub. Date: Jan. 2, 2003

(54) Apparatus for preparing microarrays

(76) Inventors: Toshiaki Tanaka, Kanagawa (JP); Mitsuhiro Tachibana, Kanagawa (JP)

Correspondence Address: CHRIS T. MIZUMOTO, Fish & Richardson P.C., Suite 2800, 45 Rockefeller Plaza, New York, NY, 10111, US

(21) Appl. No.: 10/160,872

(22) Filed: May 31, 2002

(30) Foreign Application Priority Data
Jun. 7, 2001 (JP) 2001-172989

(51) Int. Cl. B01L 3/00

(52) U.S. Cl. 422/99; 422/102; 422/104; 435/288.4; 435/305.2

(57) ABSTRACT

An apparatus for preparing microarrays which can minimize the evaporation/drying of sample solutions reserved in wells of a microtiter plate without affecting the drying of spots on a supporting member during microarray preparation, wherein it has control over feeding steam generated in a steam generator to the room of a microtiter plate-surrounding box via a filling tube to thereby increase or adjust the humidity in the neighboring space portion S above the microtiter plate placed in the microtiter plate-surrounding box to a level at which the sample solutions can hardly evaporate from the solution-reserving wells of the microtiter plate.

### BACKGROUND OF THE INVENTION

The present invention relates to an apparatus for preparing microarrays by spotting a support member with a number of sample solutions.

A prior art apparatus 101 for preparing microarrays is schematically shown in FIG. 7.

The prior art apparatus 101 for preparing microarrays is constituted, for example, such that a head 10 is moved down and up to thereby pick up a desired sample solution from one of sample solution-containing wells (to be mentioned later; cf. FIG. 8) formed on a microtiter plate (MTP) 60 placed on a pick-up site A, the head 10 is then shifted to transfer the sample solution previously picked up to a spotting site B and the head 10 is again moved down and up at this spotting site B to thereby spot a predetermined position of a supporting member 70 located there in advance with the sample solution.

Further, in the prior art apparatus 101 for preparing microarrays, the head 10, after completion of spotting of the sample solution at the predetermined position on the supporting member 70 by the series of such pick-up and spotting operations, is moved from the spotting site B to a predetermined washing/drying site C and, after washing and drying by washing/drying means 40, the head 10 is again returned to the pick-up or extraction site A where the microtiter plate is placed.

Therefore, in the prior art apparatus 101 for preparing microarrays, one and the same kind of sample or different kinds of samples can be spotted at a plurality of predetermined positions on the support member 70 in a continuous manner by repeating the above-mentioned series of operations, namely sample solution picking up, transfer of the sample solution picked up, and spotting thereof on the supporting member.

FIG. 8 is a perspective external view of a microtiter plate to be placed at the extraction site A mentioned above.

The microtiter plate 60 has a plurality of open wells 62 to serve as receptacles for sample solutions distributed thereinto as formed on the upper surface of a rectangular parallelepiped plate-like body 61, for instance. Each of the solution-reserving wells 62 can contain 5 to 50 microliters of a sample solution.

In the apparatus 101 for preparing microarrays, a needle (not shown) mounted on the head 10 is inserted into a well 62 reserving a sample solution through the opening 62a thereof and dipped in the sample solution to pick up the sample solution.

During operation, this microtiter plate 60 is prevented from moving by means of stoppers 102 disposed at the four corners of the plate, as shown in the figure, and is thus positioned at a predetermined site (extraction site A) on a plate-supporting table 80 of the microarray preparing apparatus 101.

As mentioned above, the microarray preparing apparatus 101 has a constitution such that the needle mounted on the head 10 is immersed in the sample solution in a solution-reserving well 62 of the microtiter plate 60 to pick up the sample solution. Therefore, the solution-reserving wells 62 on the microtiter plate 60 are open to the external atmosphere, namely the other portions inside the apparatus 101, so that the needle of the head 10 can enter and leave the wells.

Thus, the apparatus has a structure readily allowing the evaporation of the sample solutions reserved in the wells.

In addition, in preparing microarrays, about 18 hours is required at present to place 6,000 spots on one supporting member 70, for instance, by continuous spotting, as mentioned above, using the microarray preparing apparatus 101.

Thus, in cases where the sample spotting work requires a long period of time in microarray preparation, the above-mentioned constitution of the microtiter plate allows the sample solutions distributed into the solution-reserving wells 62 to evaporate with the lapse of time, with the result that the sample solutions reserved show different concentrations with time.

As a result, the sample contents in the spotted sample solutions become unequal to one another and, in addition, the microarray preparing apparatus 101 fails to perform uniform spotting when the spots formed at the initial sample solution spotting on the supporting member 70 are compared with those formed at the last period of spotting. Thus, the finished microarrays encounter a quality instability problem.

For preventing the sample solutions from evaporating during this time-consuming spotting process, a method is conceivable which comprises maintaining the humidity in the apparatus 101 at a high level to thereby prevent the sample solutions from evaporating from the solution-reserving wells 62 of the microtiter plate 60.

However, this method still has a problem in that spots cannot be formed stably since the microtiter plate 60 is in an open system within the apparatus 101 due to its constitution for picking up, so that the humidity in the whole apparatus 101 rises and, therefore, the spots on the supporting member 70 during microarray preparation will not dry easily but remain in a liquid state for a prolonged period of time.

### SUMMARY OF THE INVENTION

In view of the foregoing, it is an object of the present invention to provide an apparatus for preparing microarrays which can minimize the evaporation/drying of sample solutions reserved in wells of a microtiter plate without affecting the drying of spots on a supporting member during microarray preparation.

According to one aspect of the invention, there is provided a microarray preparing apparatus having a pick-up site where a microtiter plate is mounted and a solution or solutions are picked up from the microtiter plate and a spotting site where a microarray is mounted and is spotted with the solutions, wherein the apparatus comprises humidifying means for increasing the humidity at the pick-up site to a higher level as compared with the spotting site.

According to another aspect of the invention, the humidifying means comprises a surrounding member for surrounding the above-mentioned plate member.

Thus, the microarray preparing apparatus of the invention can prevent the sample solutions reserved in wells of a microtiter plate from evaporating without affecting the drying of the sample solution spots formed on the microarray during preparation.

According to another aspect of the invention, there is provided a microarray preparing apparatus having a pick-up site where a microtiter plate is mounted and a solution or solutions are picked up from the microtiter plate and a spotting site where a microarray is mounted and is spotted with the solutions, wherein the apparatus comprises cooling means for cooling the microtiter plate.

According to another aspect of the invention, the cooling means cools the microarray within the range of 0 to 15° C.

Thus, the microarray preparing apparatus of the present invention can prevent the sample solutions from evaporating by placing the microtiter plate in a lower temperature state as compared with the other portions in the apparatus without affecting the drying of spots on the microarray during preparation.

The microarray preparing apparatus according to the present invention makes it possible to prevent only the sample solutions on the microtiter plate from evaporating by placing the microtiter plate in a box for exclusive use therefor and controlling the humidity and temperature only in the box, without disturbing the drying of sample solution spots on the member supporting the microarray during preparation.

Thus, even when a long period of time is required for microarray preparation, the spot formation can be effected in a stable manner.

Other and further objects, features and advantages of the invention will appear more fully from the following description.

### BRIEF DESCRIPTION OF THE DRAWINGS

In the attached drawings:

FIG. 1 is a schematic view illustrating the constitution of an embodiment of the microarray preparing apparatus 1 according to the present invention;

FIG. 2 is a perspective external view showing a microtiter plate-surrounding box 20 to be placed in the microarray preparing apparatus 1 according to the above embodiment;

FIG. 3 is a sectional view of the microtiter plate-surrounding box 20;

FIG. 4 is a schematic representation illustrating the operation of the microarray preparing apparatus 1 according to the above embodiment;

FIG. 5 is an external view of another microtiter plate-surrounding box 220;

FIG. 6 is a sectional view of the microtiter plate-surrounding box 220;

FIG. 7 is a schematic representation of a prior art microarray preparing apparatus; and

FIG. 8 is an external view of a microtiter plate mounted on the extraction site A.

### DETAILED DESCRIPTION OF THE PREFERRED EMBODIMENTS

In the following, preferred embodiments of the present invention are described referring to the accompanying drawings.

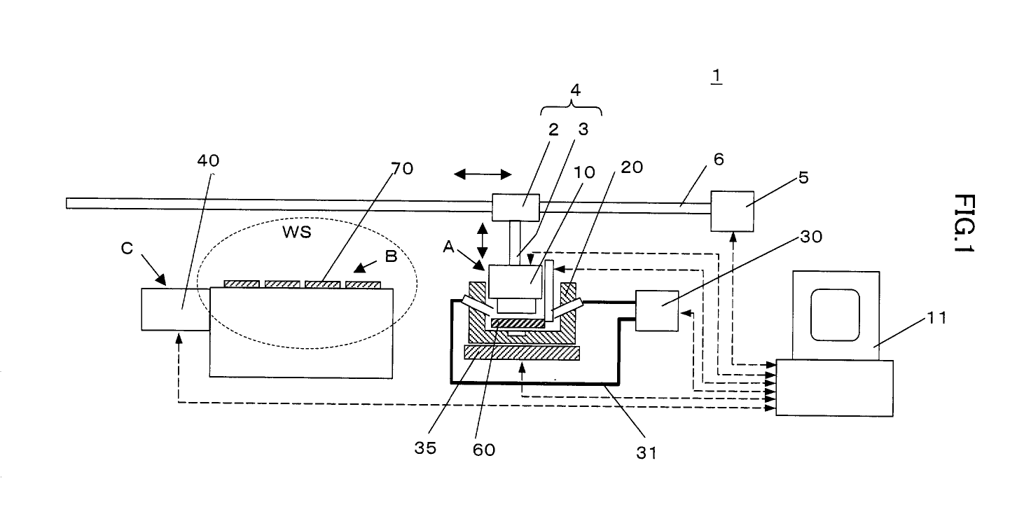

FIG. 1 is a schematic view illustrating the constitution of an embodiment of the microarray preparing apparatus 1 according to the present invention.

In the following description, those parts or members which have the same constitution as in the prior art are indicated in the figures by the same reference numbers, and the detailed description thereof is omitted.

In the microarray preparing apparatus 1 according to this embodiment, the head 10 for picking up a sample solution from a microtiter plate 60 set at the extraction site A and spotting a microarray supporting member 70 mounted on the spotting site B with the sample solution picked up can be moved up and down along a guide shaft 3 by driving a hoisting and lowering motor 2.

This head 10 is connected with the hoisting and lowering motor 2 via the guide shaft 3 and integrally constitutes a mobile unit 4, and this mobile unit 4 can be horizontally shifted along a guide shaft 6 from the extraction site A to the spotting site B, further to a washing/drying site C, and again to the extraction site A and so on by means of a feeder motor 5.

The hoisting and lowering motor 2 and feeder motor 5 are controlled by a controller 11, and the position of the head 10 is controlled by the operations of these motors 2 and 5.

Thus, the controller 11 controls the operation of the hoisting and lowering motor 2 according to an operation menu (microarray preparing program) programmed and inputted thereinto in advance to thereby move the head 10 down and up at the extraction site A, spotting site B, and washing/drying site C for extraction, spotting, and washing/drying, respectively.

The controller 11 also controls the operation of the feeder motor 5 according to the operation menu (microarray preparing program) programmed and inputted thereinto in advance to thereby move the mobile unit 4, inclusive of the head 10, from the extraction site A to the spotting site B, further to the washing/drying site C, and again to the spotting site and so on.

Further, the controller 11 controls the operation of the washing/drying means 40 in association with the above-mentioned up and down movement and shifting of the head 10.

Meanwhile, at the extraction site A in the microarray preparing apparatus 1, there is provided a microtiter plate-surrounding box 20 for holding the microtiter plate 60 therein during microarray preparation.

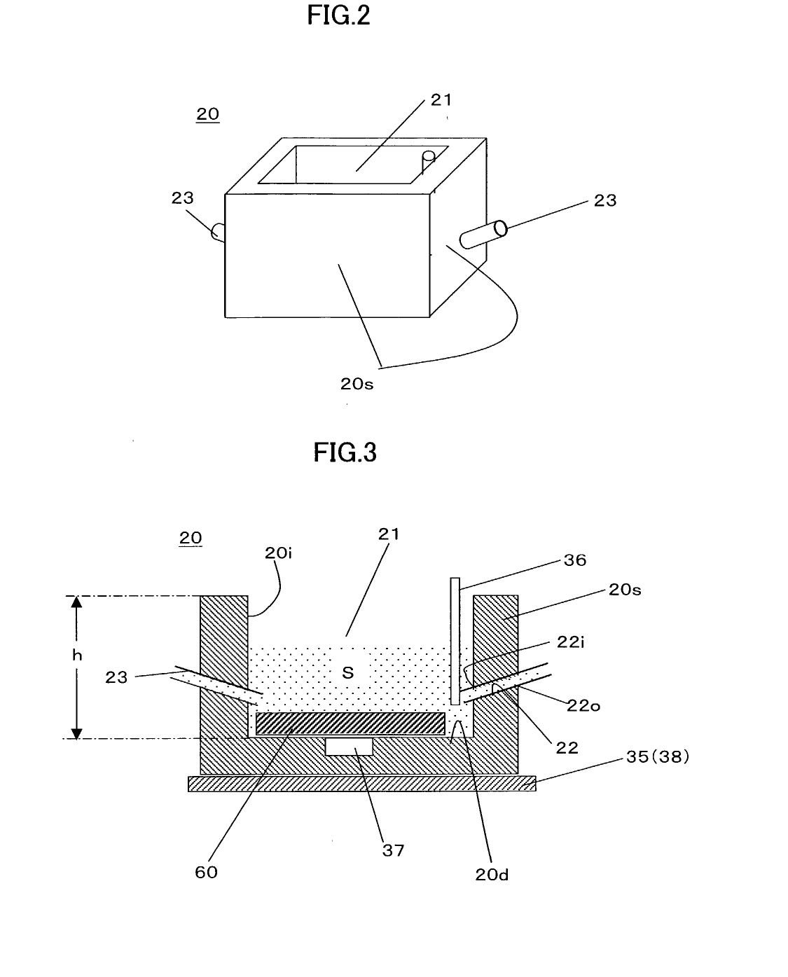

FIG. 2 is a perspective external view showing a microtiter plate-surrounding box 20 to be placed in the microarray preparing apparatus 1 according to the above embodiment.

FIG. 3 is a section view of this microtiter plate-surrounding box 20.

In this mode of embodiment, the microtiter plate-surrounding box 20 has a rectangular parallelepiped-like form, and there is a room 21 formed therein with the upper side opened and the bottom closed.

The microtiter plate 60 is mounted and positioned on the bottom surface 20d of the room 21.

The side wall portion 20s of the microtiter plate-surrounding box 20 is constituted so that it has a height h sufficient to surround the sides of the microtiter plate 60 placed in the room 21 as well as a neighboring space S above the microtiter plate 60.

An appropriate number of through holes 22 connecting the room 21 to the outside of the microtiter plate-surrounding box 20 are formed in and around the side wall portion 20s of the microtiter plate-surrounding box.

In this mode of embodiment, the opening 22i, on the room 21 side, of each through hole 22 opens into the microtiter plate-surrounding box 20 in a manner opposing to the inner side wall surface, and the position of the opening is slightly higher than the open upper surface of solution-reserving wells 62 of the microtiter plate 60 when this is placed in the room 21. On the contrary, the opening 22o, on the side external to the side wall portion 20s, of the through hole 22 is located higher than the position of the opening 22i, so that through hole 22 has a slanting hole structure with its position on the outside surface of the side wall portion 20s being higher than the position on the inside surface side.

In this embodiment, a filling tube 23 is inserted into each through hole 22, with its one end extending from the inside surface of the side wall portion 20s into the room 21 and the other end protruding from the outside surface of the side wall portion 20s.

That portion of this filling tube 23 which is extruding from the outside surface is connected with a steam pipeline from a steam generator 30 to be mentioned later (cf. FIG. 1). Steam generated in the steam generator 30 is fed, through the filling tube 23, to the neighboring space S above the microtiter plate in the box 20 and retained there.

Since the humidity in the inside room 21 of the microtiter plate-surrounding box 20 increases accordingly, aluminum is used, in this embodiment, as the material of the microtiter plate-surrounding box 20 itself for rust prevention.

The material of the microtiter plate-surrounding box 20 is not limited to a rustproof metal such as aluminum but may be a heat- and corrosion-resistant resin, for instance. It is not always necessary for the whole microtiter plate-surrounding box 20 itself to be made of a rustproof material, but a constitution may also be employed such that the inside surface 20i and bottom 20d of the room 21 in the microtiter plate-surrounding box 20, which are exposed to steam, are covered with a rustproof metal such as aluminum or with a heat- and corrosion-resistant resin.

The height h of the side wall portion 20s of the microtiter plate-surrounding box 20 mentioned above is such that the steam fed remains in the room 21 and, thereby, the inside of the room 21 of the microtiter plate-surrounding box 20 is exclusively maintained in a humidified state by the steam fed and that the steam fed can hardly escape from the upper opening of the microtiter plate-surrounding box 20 and thus can hardly go to other portions of the apparatus 1, in particular to the spotting work space WS (cf. FIG. 1) where the supporting member 70 is placed.

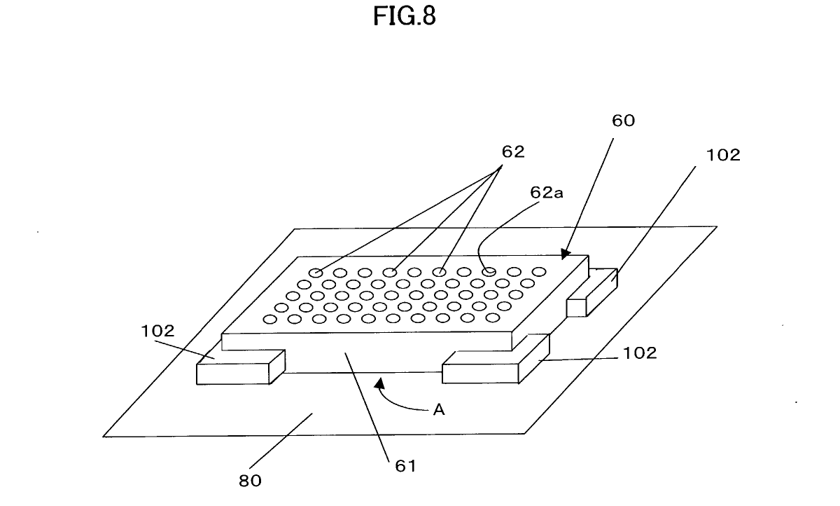

Therefore, the height h of the side wall portion 20s of the microtiter plate-surrounding box 20 is to be selected taking into consideration such factors as the thickness of the microtiter plate 60, the cross-sectional area of the upper opening of the microtiter plate-surrounding box 20, and the amount of steam necessary for preventing the sample solutions from evaporating from the solution-reserving wells 62 (cf. FIG. 8) of the microtiter plate 60. In this embodiment, the height h is, for example, 10 cm.

In the steam generator 30, deionized water is used as water for generating steam in this embodiment so that the sample solutions can be prevented from being contaminated with foreign matters.

Furthermore, the microarray preparing apparatus 1 according to this mode of embodiment comprises, in addition to the steam feeding means including the above-mentioned steam generator 30, steam feeding pipeline 31 and filling tubes 23 (through holes 22), a cooling device 35 comprising a Peltier device 38, for instance, disposed at the bottom of the microtiter plate-surrounding box 20 so that the sample solutions can be prevented from evaporating from the solution-reserving wells 62 (cf. FIG. 8) of the microtiter plate.

The cooling device 35 cools the microtiter plate 60 via the microtiter plate-surrounding box 20 and maintains the liquid temperature within the solution-reserving wells 62 (cf. FIG. 8) and the atmospheric temperature around the microtiter plate 60 within the room 21 at a constant level.

The steam concentration within the room 21 of the microtiter plate-surrounding box 20, and the temperature of the microtiter plate 60 are controlled and adjusted by the controller 11, which controls the steam generator 30 and cooling device 35 based on the signals detected and provided by a humidity sensor 36 and a temperature sensor 37.

The microarray preparing apparatus 1 in this mode of embodiment is constituted as mentioned above. The working thereof is now described.

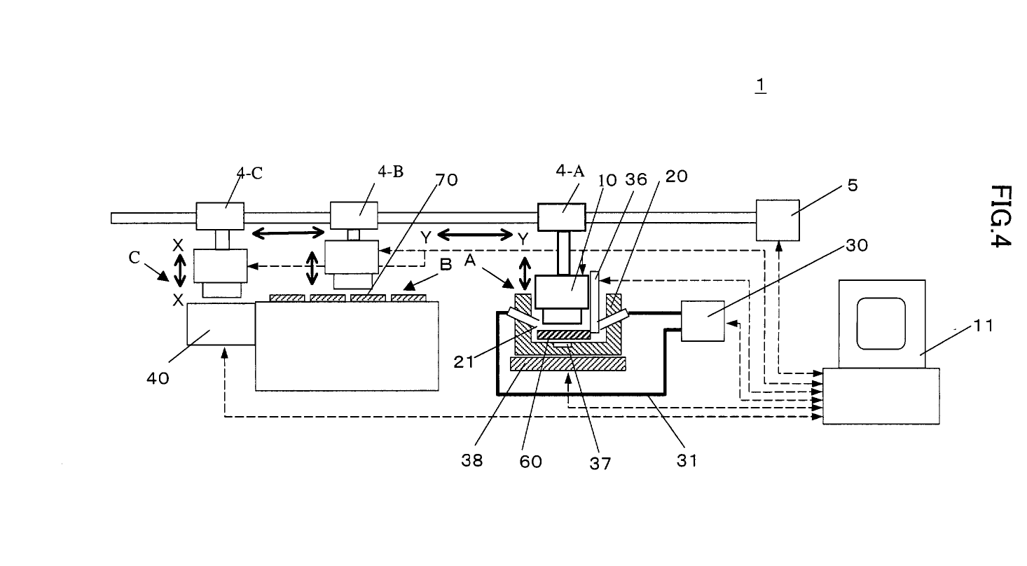

FIG. 4 is a schematic representation illustrating the operation of the microarray preparing apparatus 1 according to the above mode of embodiment.

As shown in FIG. 4, the microarray preparing apparatus 1 is started in a state with a microtiter plate 60 placed in the microtiter plate-surrounding box 20.

Upon starting, the controller 11 drives the feeding motor 5 to position the mobile unit 4 at the extraction site A above the microtiter plate-surrounding box 20, then drives the hoisting and lowering motor 2 to move the head 10 down into the room 21 of the microtiter plate-surrounding box 20 and, after picking up of a desired sample solution from a solution-reserving well 62 (cf. FIG. 8), which reserves the desired sample solution, of the microtiter plate 60, again drives the hoisting and lowering motor 2 to move the head 10 out of the room 21 of the microtiter plate-surrounding box 20 (a series of operations at the moving position indicated by the symbol 4-A in FIG. 4).

The controller 11 then drives the feeder motor 5 to move the head 10 to the spotting site B where a supporting member 70 to be spotted with the sample is placed and, on this spotting site, it drives the hoisting and lowering motor 2 to move the head 10 down for spotting of the sample solution at a predetermined position of the supporting member 70 (a series of operations at the moving position indicated by the symbol 4-B in FIG. 4). The supporting member 70 is constituted of a slide glass, for instance.

After completion of spotting at the predetermined position, the controller 11 drives the feeding motor 5 to move the head 10 to the washing/drying site C above the washing/drying means 40 and drives the hoisting and lowering motor 2 to move down and up for washing/drying thereof by the washing/drying means 40 (a series of operations at the moving position indicated by the symbol 4-C in FIG. 4) in preparation of the next spotting of another sample solution.

After completion of this washing/drying step, the controller 11 drives the feeding motor 5 to return the head 10 again to the extraction site A above the microtiter plate-surrounding box 20.

And, by repeating such horizontal movements (in the direction of Y-Y in FIG. 4) of the mobile unit including the head 10 from the extraction site A to the spotting site B, further to the washing/drying site C and again to the site A and the up and down movements of the head 10 on each site (in the direction of X-X in FIG. 4), spots are formed one by one on the supporting member 70.

During this series of operations for spotting, the controller 11 controls the steam generator 30 based on the results of detection by the humidity sensor provided in the microtiter plate-surrounding box to thereby control the feeding of steam generated in the steam generator 30 into the room 21 of the microtiter plate-surrounding box 20 via the filling tube 23 and thus maintain the humidity of the neighboring space S above the microtiter plate 60 placed in the microtiter plate-surrounding box 20 within a predetermined steam concentration range, namely predetermined humidity range, necessary for preventing the sample solutions from evaporating from the solution-reserving wells 62 (cf. FIG. 8) of the microtiter plate 60.

In this mode of embodiment, the predetermined humidity range for the neighboring space S above the microtiter plate is, for example, not less than 90%. Thus, when a humidity lower than the lower limit 90% of this predetermined humidity range is detected by the humidity sensor 36, the controller 11 drives the steam generator 30 for feeding steam for humidification. When the humidity as detected by the humidity sensor 36 is at a higher level than the lower limit 90% of the predetermined humidity range, the controller 11 stops driving the steam generator 30 to thereby stop the feeding of steam.

In this manner, the neighboring space S above the microtiter plate in the microtiter plate-surrounding box 20 is maintained at a humidity of 90% or higher, namely within the predetermined humidity range, by the steam generated in the steam generator 30, and the sample solutions are prevented from evaporating from the solution-reserving wells 62 (cf. Fog. 8) of the microtiter plate 60.

During the same series of operations for spotting, the controller 11 also drives and controls the Peltier device 38 as cooling means, based on the results of detection by the temperature sensor 37 provided in the microtiter plate-surrounding box 20, to lower the temperature of the sample solutions in the solution-reserving wells 62 of the microtiter plate 60 placed in the microtiter plate-surrounding box 20, and the temperature of the atmosphere surrounding the microtiter plate 60 within the room 21 (including at least part of the neighboring space S above the microtiter plate) of the microtiter plate-surrounding box 20, each to a predetermined level to thereby inhibit the sample solutions themselves from evaporating as otherwise resulting from rises in liquid temperature while maintaining the humidity around the microtiter plate within the room 21 at a high level, or making it difficult to lower.

In this mode of embodiment, the predetermined temperature within the microtiter plate-surrounding box 20 and in the neighboring space portion S above the plate is between 0° C. and 15° C., more specifically it is the same as the sample storing temperature, for example 4° C.

In this way, the sample solution temperature in the solution-reserving wells 62 of the microtiter plate 60 and the atmosphere temperature around the microtiter plate 60 in the room 21 of the microtiter plate-surrounding box 20 are maintained at a predetermined level (for example 4° C.) based on the results detected by the temperature sensor 37, and the sample solutions are prevented from evaporating from the solution-reserving wells 62 (cf. Fog. 8) of the microtiter plate.

As a result, the microarray preparing apparatus 1 according to this mode of embodiment of the invention makes it possible to prevent only the sample solutions on the microtiter plate 60 from evaporating by placing the microtiter plate 60 in the microtiter plate-surrounding box 20 and controlling the humidity and/or temperature within the box.

Since the microtiter plate-surrounding box 20 has a sufficient depth so that the humidity and/or temperature therein can be controlled, only the sample solutions on the microtiter plate can be prevented from evaporating by controlling only the humidity and/or temperature around the microtiter plate 60, without causing any trouble in sample solution picking up from above by the head 10.

Therefore, the sample solutions on the microtiter plate 60 are prevented from changing in concentration with time during a long period of time required for microarray preparation, the viscosity of each sample solution is also maintained, and the spotted sample solutions on the supporting member 70 are not prevented from drying. Thus, the spots become stabilized.

Furthermore, the steam generator 30 and cooling device 35 for preventing the sample solutions on the microtiter plate 60 from evaporating each may be of small size and small capacity.

The microarray preparing apparatus 1 in the above mode of embodiment is constituted in the above manner. It is, however, by no means limitative of the scope of the invention.

Thus, for example, while the cooling device 35 has a direct cooling constitution utilizing a Peltier device 38 in the above embodiment, an indirect cooling constitution involving feeding or circulation of cold air or cold water may also be employed.

The mechanisms for moving the head 10 for sample solution extraction or spotting, for instance, are not limited to the constitution mentioned hereinabove referring to FIG. 4.

Further, the constitution of the microtiter plate-surrounding box 20 is not limited to the constitution shown in FIG. 2 and FIG. 3.

FIG. 5 is an external view of another microtiter plate-surrounding box 220.

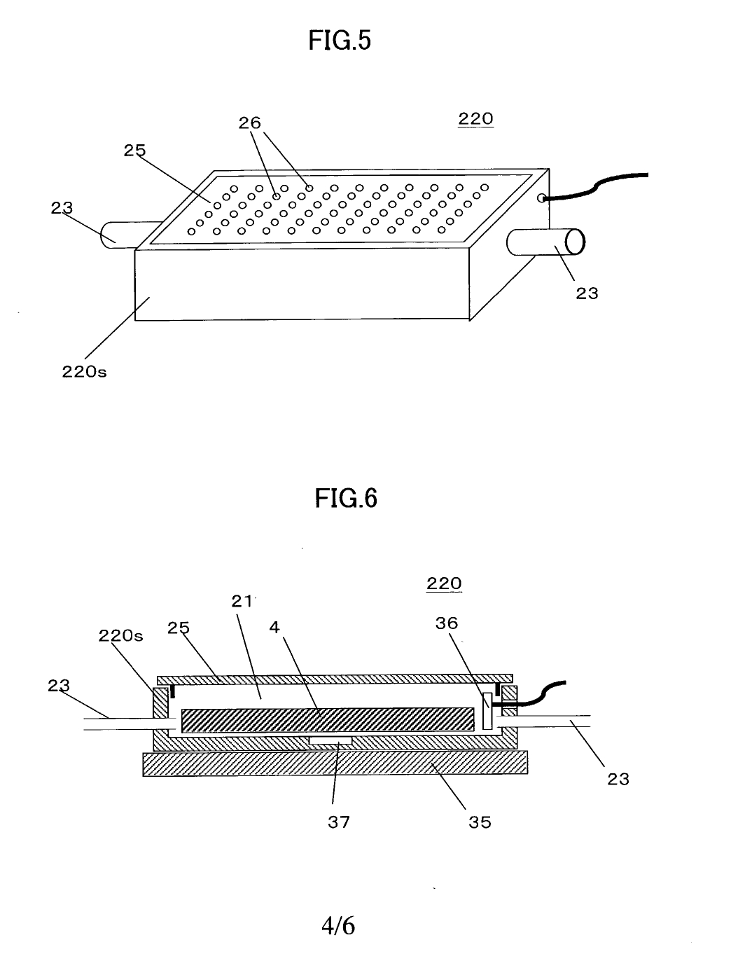

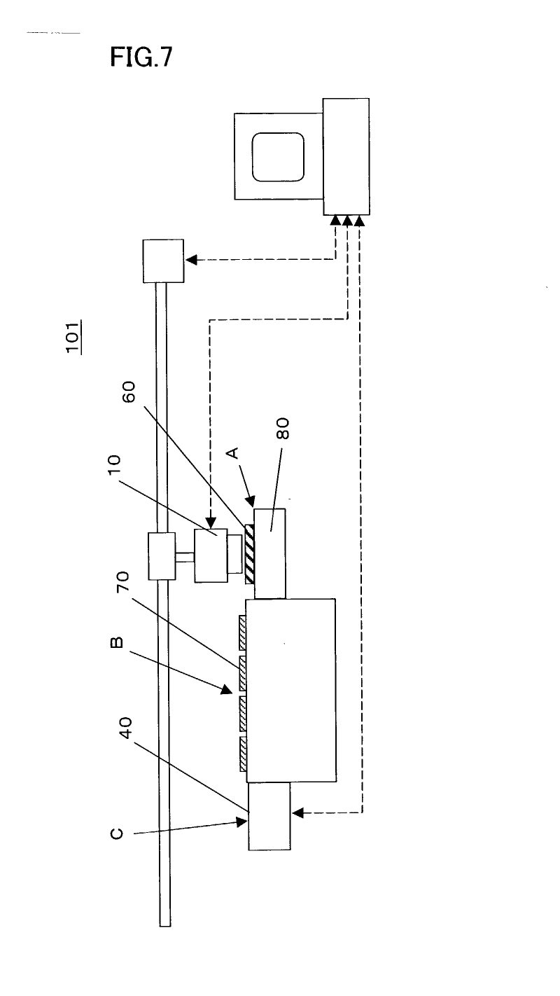

FIG. 6 is a sectional view of the microtiter plate-surrounding box 220.

In describing the box 220, the same parts or elements as those of the microtiter plate-surrounding box 20 are given the same symbols and the explanation thereof is omitted.

As compared with the microtiter plate-surrounding box 20 mentioned above, the microtiter plate-surrounding box 220 has a constitution such that the opening is closed by a cover member 25 with a plurality of through holes 26 formed therein for allowing the passage of the needle (not shown) mounted on the head 10.

For that purpose, this plurality of through holes 26 are formed so that when the opening of the microtiter plate-surrounding box 220 is covered with the cover member 25, their positions can coincide with the respective openings 63 of the solution-reserving wells 62 of the microtiter plate 60 positioned in the room 21.

This constitution can reduce the area of the portions opened to the outside of the microtiter plate-surrounding box 220, whereby the dissipation of steam from the room 21 to the outside can be restricted, hence the height h of the side wall portion 220s as required for maintaining the room 21 alone of the microtiter plate-surrounding box 20 in a humidified state can be reduced.

The through holes 26 may be integrated into one large hole.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. An apparatus for preparing microarrays which has a pick-up site where a microtiter plate is mounted and a solution is picked up from the microtiter plate and a spotting site where a microarray is mounted and is spotted with the solution, wherein the apparatus comprises humidifying means for increasing the humidity at the pick-up site to a higher level as compared with the spotting site.

2. A microarray preparing apparatus according to claim 1 which further comprises a surrounding member for surrounding the above-mentioned plate member.

3. An apparatus for preparing microarrays which has a pick-up site where a microtiter plate is mounted and a solution is picked up from the microtiter plate and a spotting site where a microarray is mounted and is spotted with the solution, wherein the apparatus comprises cooling means for cooling the microtiter plate.

4. A microarray preparing apparatus according to claim 3, wherein the cooling means cools the microarray within the range of 0 to 15° C.

5. An apparatus for preparing microarrays which has a pick-up site where a microtiter plate is mounted and a solution is picked up from the microtiter plate and a spotting site where a microarray is mounted and is spotted with the solution, wherein the apparatus comprises humidifying means for increasing the humidity at the pick-up site to a higher level as compared with the spotting site and wherein the apparatus comprises cooling means for cooling the microtiter plate.

6. A microarray preparing apparatus according to claim 5 which further comprises a surrounding member for surrounding the above-mentioned plate member.

7. A microarray preparing apparatus according to claim 5, wherein the cooling means cools the microarray within the range of 0 to 15° C.
